(19) United States
(12) Patent Application Publication
(10) Pub. No.: US 2013/0201410 A1
(43) Pub. Date: Aug. 8, 2013

(54) MULTIMEDIA APPARATUS

(71) Applicant: Chanan Gardi, Impruneta Firenze (IT)

(72) Inventor: Chanan Gardi, Impruneta Firenze (IT)

(21) Appl. No.: 13/637,857

(22) PCT Filed: Mar. 28, 2011
(86) PCT No.: PCT/IB11/00659

§ 371 Date: Feb. 8, 2013

(30) Foreign Application Priority Data
Mar. 27, 2010 (IT) BO2010A000193

(51) Int. Cl. H04N 9/31

(52) U.S. Cl. CPC H04N 9/3141
USPC 348/789

(57) ABSTRACT

Multimedia apparatus characterized in that it comprises:—a control unit (100) which comprises an audio/video source and/or is connected to an audio/video source;—a structure (1) for audio/video reproduction connected to said control unit (100) and provided with at least a projector (2), i.e. with means for displaying images (2); said structure (1) being positionable according to different configurations in order to place correspondingly said projector (2), with the possibility of lifting, lowering and/or rotate around a vertical axis the same projector;—a reflecting element (22) adjustable, placed in correspondence of said means for displaying images (2), capable of diverting at least vertically, the projection out from said means for displaying images (2).

The present invention relates to a multimedia apparatus.

In particular, the multimedia apparatus of the invention can be used for playing audio/video media. The apparatus can be provided, in addition, with one or more light sources that enable it to be used as a lamp.

The aim of the present invention is to provide full multimedia apparatus, capable of projecting on different surfaces, arranged on different planes, images and sounds produced from different sources; for example, analog television channels can be used, as digital and satellite channels radio, cable connections, internet connections or via other computer networks, audio/video CD, DVD, and the like, various types of storage media, cameras or other recording media, etc.

One of the advantages of the present invention is that it is possible to reproduce on different planes that constitute corresponding screens at different angles and heights. A typical application is playing on the (four) walls of a room, with possibility of viewing at different heights and different distances from the point in which is placed the apparatus of the present invention. In practice, the structure for audio/video playing can be placed basically anywhere in the room, for example resting on the floor or attached to the ceiling; from the point where the structure is placed, the same structure can vary the height and angle, with respect to a vertical axis, of the light radiation emitted so as to allow the projection on screens which are placed at different heights and different positions, also made by the same walls that surround the room. The apparatus also allows the projection on plane which are different from the walls of the room in which it is placed; the apparatus in fact, in a possible embodiment, can project downwardly, upwardly, etc., thanks to a reflecting element can conveniently deflect the radiation emitted from the projector.

Another advantage is that the apparatus can be placed substantially anywhere in the space, so as to be integrated not only with the room, but to constitute a primary element of the interior architecture. In other words, the apparatus itself becomes an item of furniture.

Another advantage is that the apparatus can provide a multimedia structure extremely flexible and efficient in conjunction with a source of light.

Another advantage is the wireless connection of the apparatus with its source of data/programs in order to make easy its location in any room.

The same apparatus can also be integrated in a cabinet or a part thereof, such as, for example, a table, making it an integrated structure with a great variety of functions.

This result was reached in accordance with the invention by adopting the idea of making a device having the characteristics described in the independent claim.

Other features are described in the dependent claims.

Among the advantages of the present invention are, therefore, the following:
it is possible to play video in environments/rooms of any size and shape, thanks to the possibility to orient the projector element in a substantially total way;
there are no constraints on the size of screens, being possible to project onto any suitable surface, with the possibility to range over 360°;
it is possible to use the same object with a dual function: as a device for playing video/audio and as a light, providing an added value, both technically and aesthetically, surprisingly higher than the sum of the two individual components;
the structure provides high safety in operation (both audio/video playing and lighting), combined with incredible ease in changes among its functions.

These and other advantages and features of the present invention will be better understood by means of the following description and with the help of the annexed drawings, given as practical examples of the invention, but not to be considered by limiting, in which:

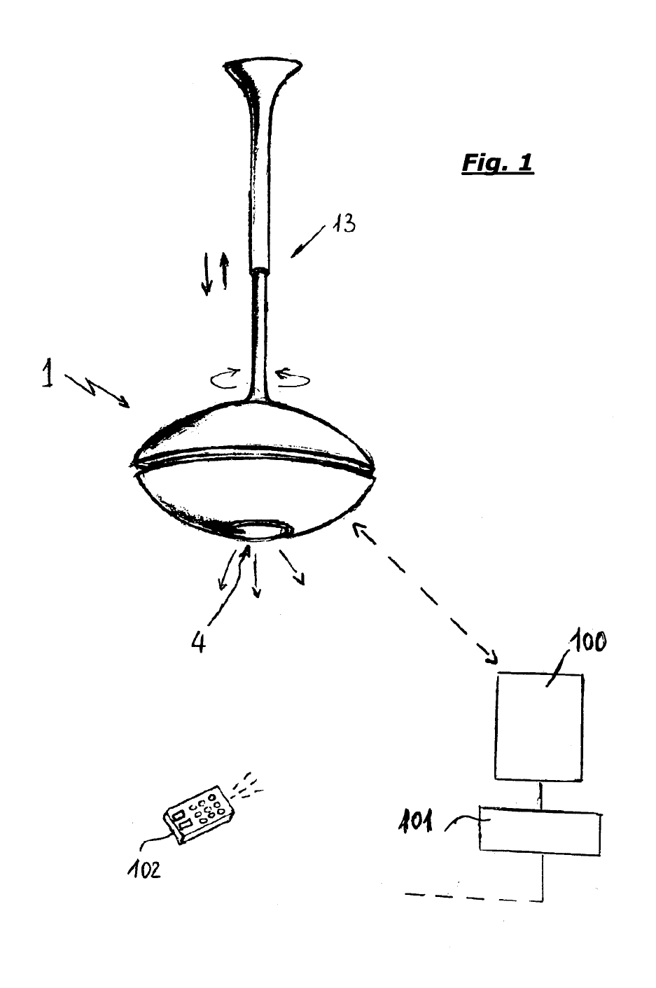

FIG. 1 shows, in a schematic perspective view with parties represented by blocks, a possible embodiment of an apparatus in accordance with the invention;

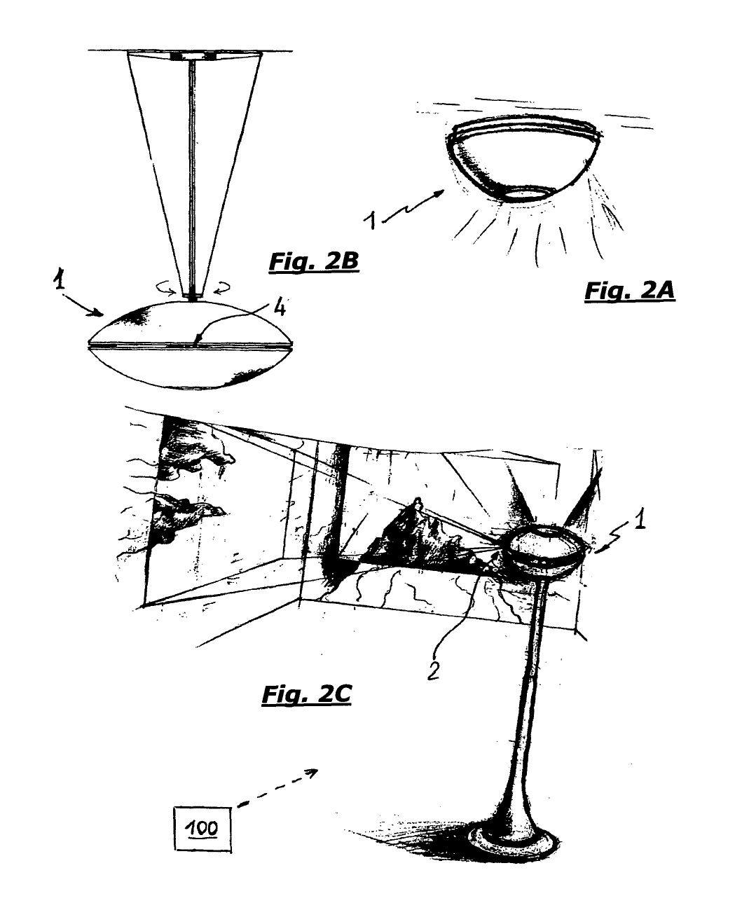

FIGS. 2A, 2B, 2C show, schematically in perspective view, three possible embodiments of the apparatus; in FIG. 2 the apparatus is attached directly to the ceiling; in FIG. 2B the apparatus is attached to the ceiling by means of a rod; in FIG. 2C the apparatus is resting on the floor by means of a foot;

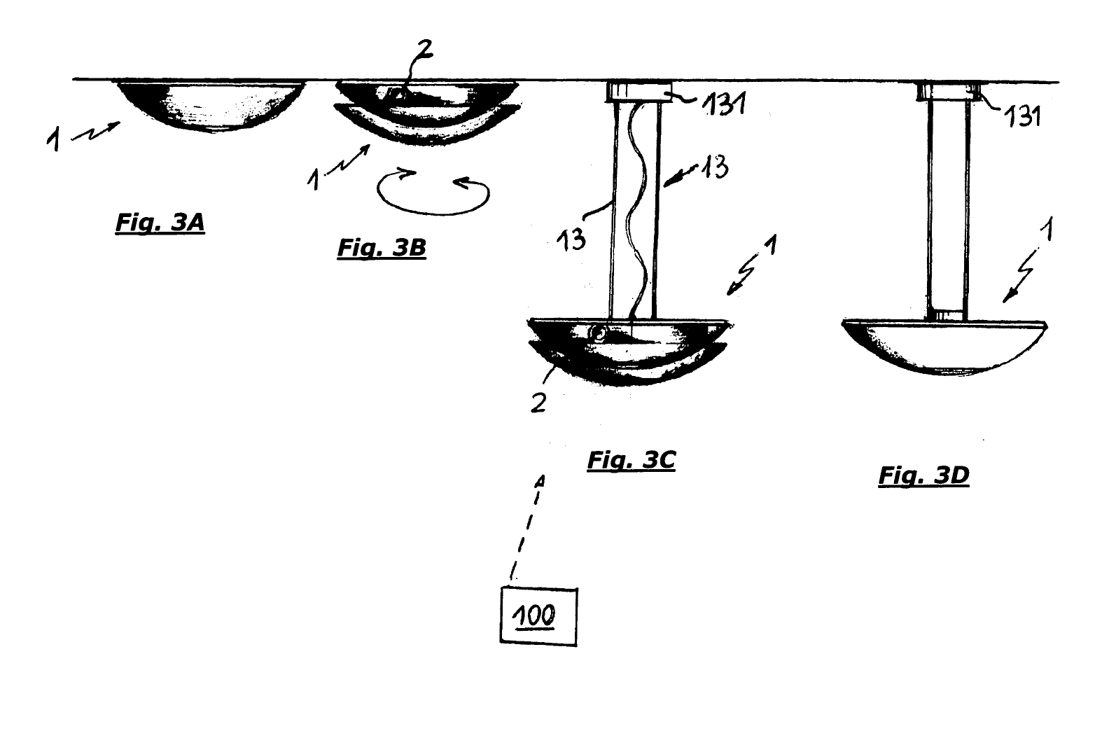

FIGS. 3A, 3B, 3C and 3D show, schematically in side view, another possible embodiment of the apparatus, where apparatus is attached to the ceiling and is reproduced in different operational phases;

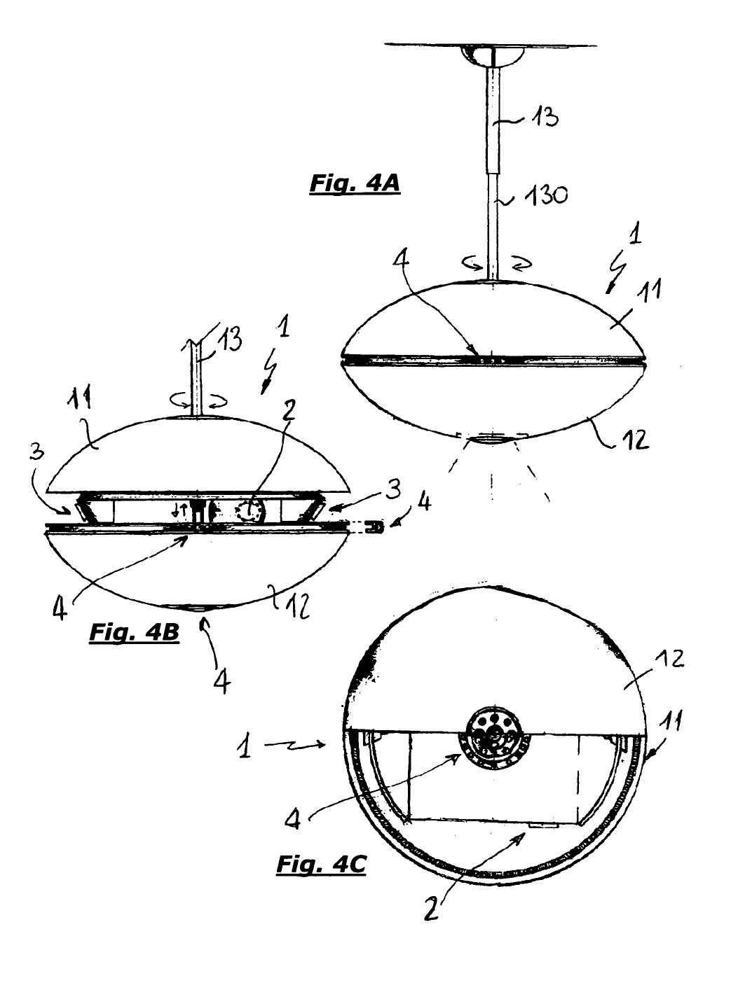

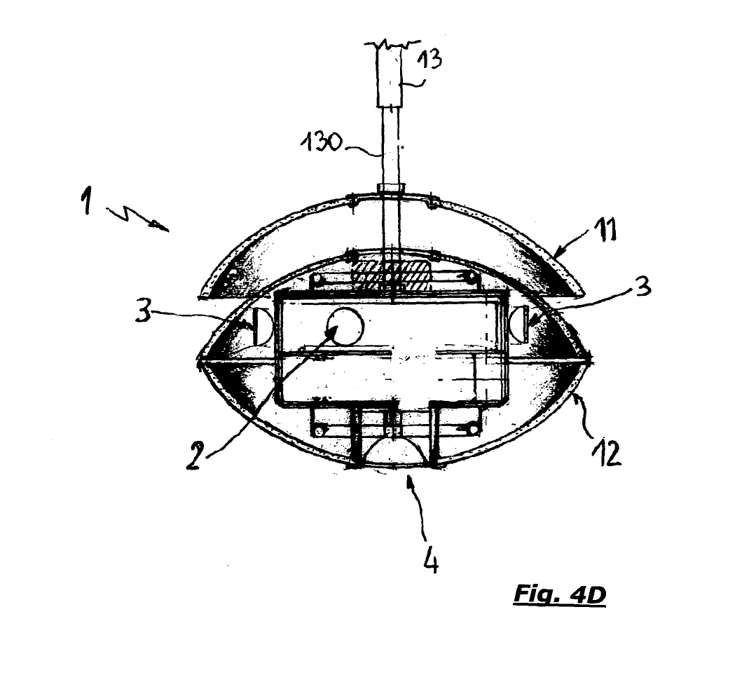

FIGS. 4A, 4B, 4C, 4D show schematically another possible embodiment of the apparatus; the apparatus is fixed to the ceiling using an extendable rod and it is shown in different operational phases; in particular, FIGS. 4A and 4B are side views, FIG. 4C is a plan view from below, FIG. 4D is a schematic side view with parts in transparency and with the representation of two operating configurations, which are, respectively, the opening (with the higher half-shell up) and closing (with the higher half-shell down);

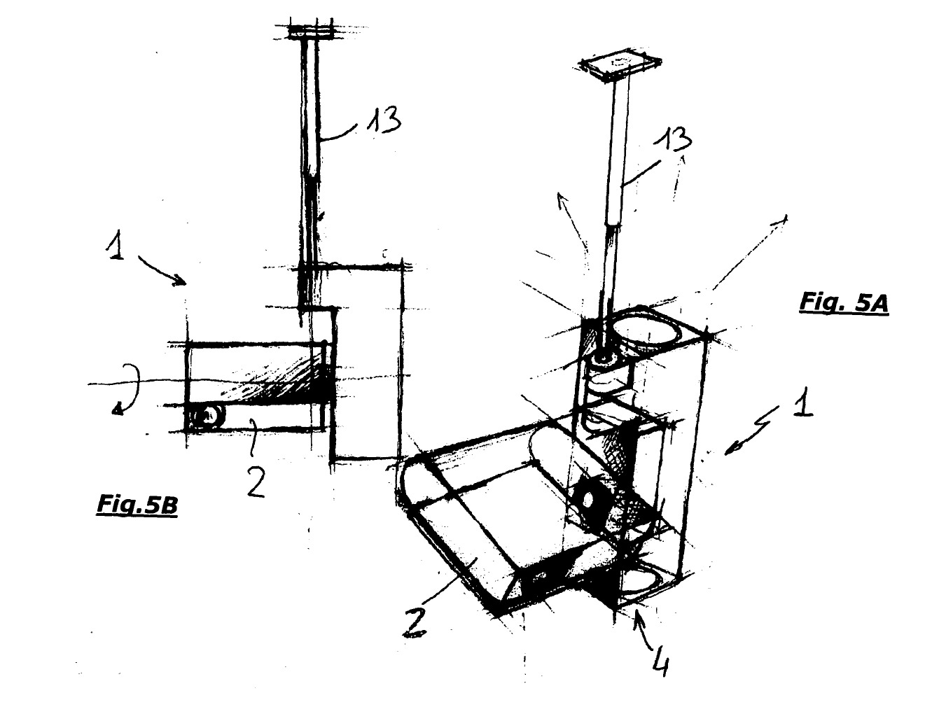

FIGS. 5A, 5B show schematically another possible embodiment in accordance with the invention in which the apparatus is hung from the ceiling by a telescopic rod; FIG. 5A is a perspective view, FIG. 5B is a front view;

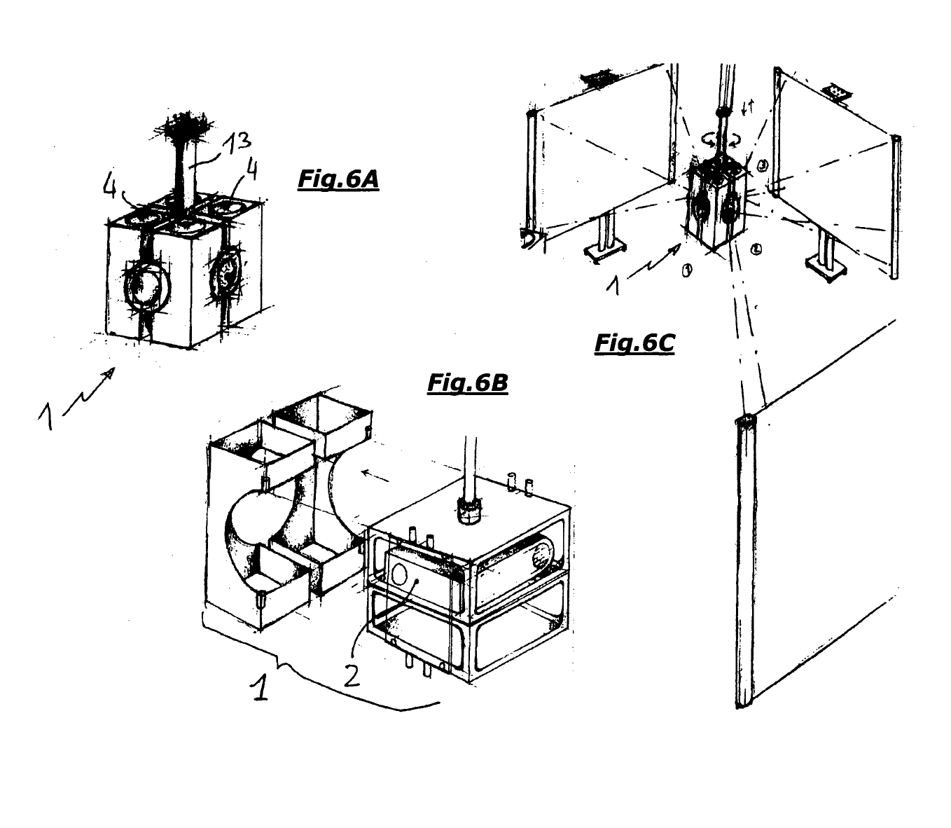

FIGS. 6A, 6B, 6C, show, schematically in perspective view, another possible embodiment of the apparatus, with the body of the structure suspended to the ceiling is formed by prismatic box elements;

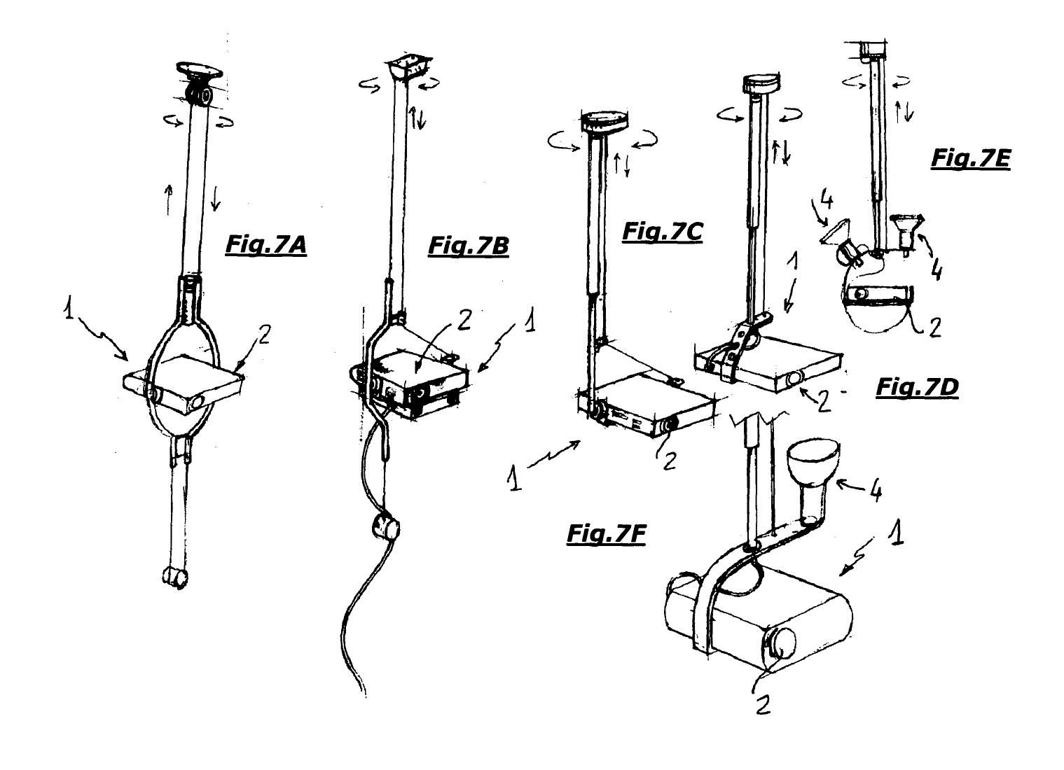

FIGS. 7A, 7B, 7C, 7D, 7E, 7F show, schematically in perspective view, further embodiments of the apparatus, in which the structure for playing audio/video is attached to the ceiling with the possibility to rotate around a vertical axis, and in which a projector is attached to the same structure with the possibility to rotate around a horizontal axis;

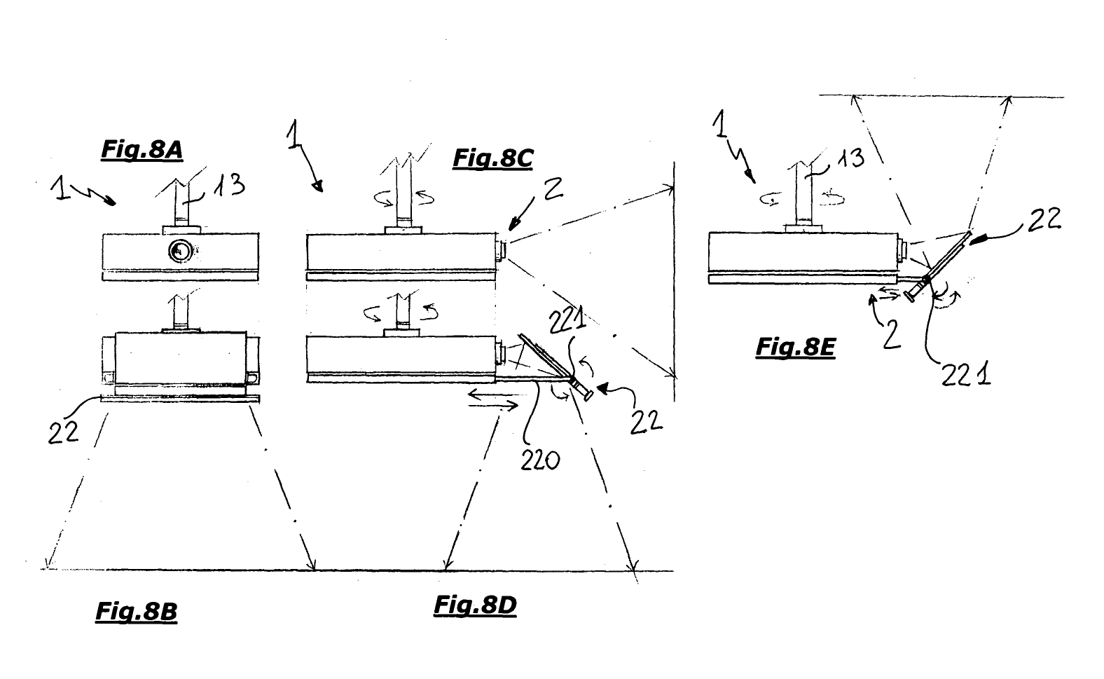

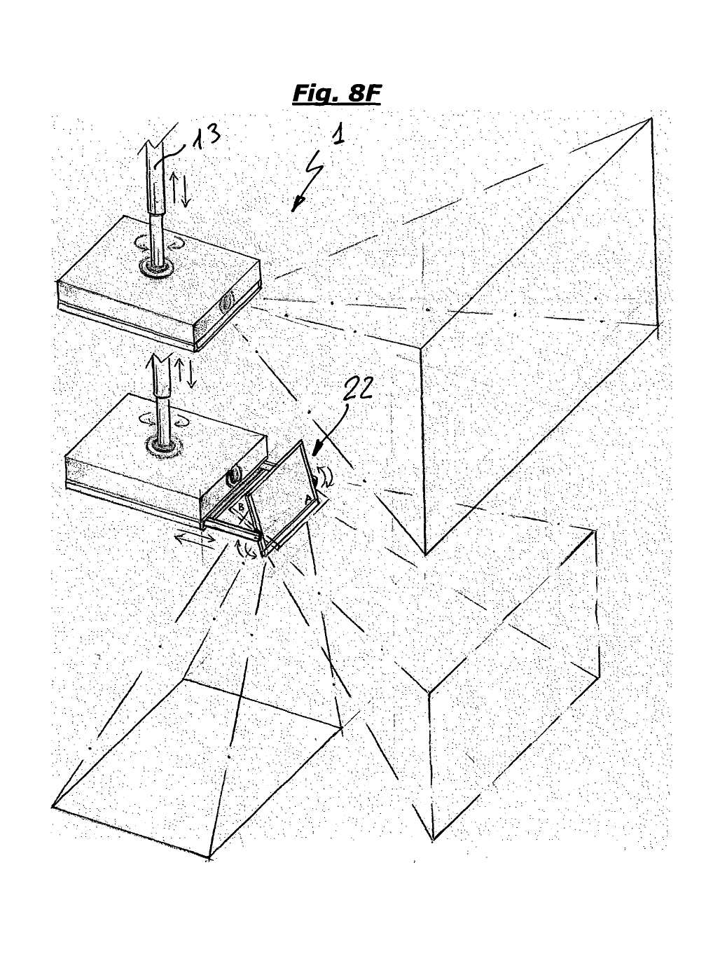

FIGS. 8A, 8B, 8C, 8D, 8E, 8F show another embodiment of the present invention in which the projector is integrated with an adjustable mirror; FIG. 8A is a front view of the apparatus in active configuration in which the reflecting element is not extracted from the apparatus and the projector can project in a horizontal direction; FIG. 8C is the corresponding side view; FIG. 8B is the front view of the apparatus in the open configuration, i.e. with the mirror that protrudes from the apparatus and reflects downward the projection of the projector; FIG. 8D is the corresponding side view; FIG. 8E is a front view of the apparatus in the open configuration with the mirror that reflects upward the projection of projector; FIG. 8F is a schematic perspective view: in the upper part of the drawing the apparatus the projector projects in a horizontal direction, while in the lower part, thank to the mirror element, the apparatus can also project vertically;

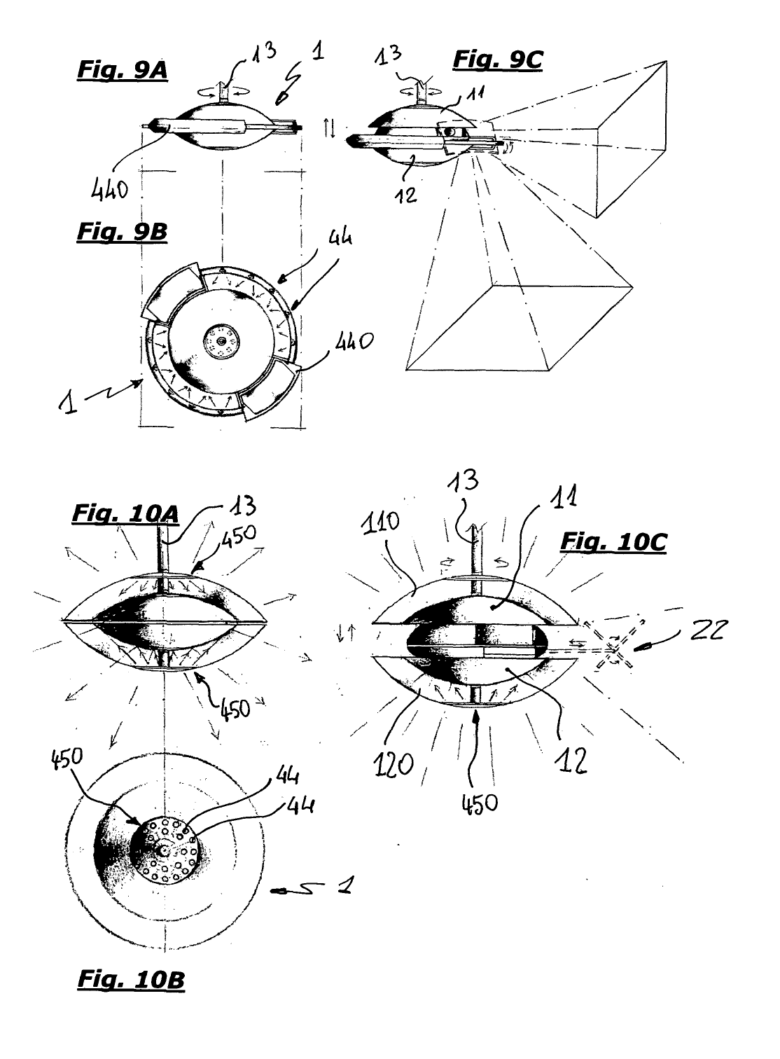

FIGS. 9A, 9B, 9C schematically show another embodiment of the invention, in which the apparatus has a substantially circular shape in plan and it is provided with a mirror element; FIG. 9A is a side view; FIG. 9B is a plan view from below; FIG. 9C is a perspective view with the structure in the open configuration, i.e. with the two half-shelves which form the structure that are separated from each other;

FIGS. 10A, 10B, 10C show schematically a further embodiment of the invention, in which the apparatus has a substantially circular shape in plan and is provided with a mirror element; FIG. 10A is a side view; FIG. 10B is a plan view from below; FIG. 10C is a perspective view with the structure in the open configuration, i.e. with the two half-shelves which form the structure that are separated from each other;

FIGS. 11A, 11B, 11C show schematically another further embodiment of the invention, in which the apparatus is supported by a table and slides vertically upwards from the tabletop when it is used, both as a projector as a lamp; FIG. 11 is a side view in which the apparatus is inside the table, and FIG. 11B and FIG. 11C are, respectively, a side view and a perspective view in which the apparatus is shown in open configuration in which protrudes from the table top;

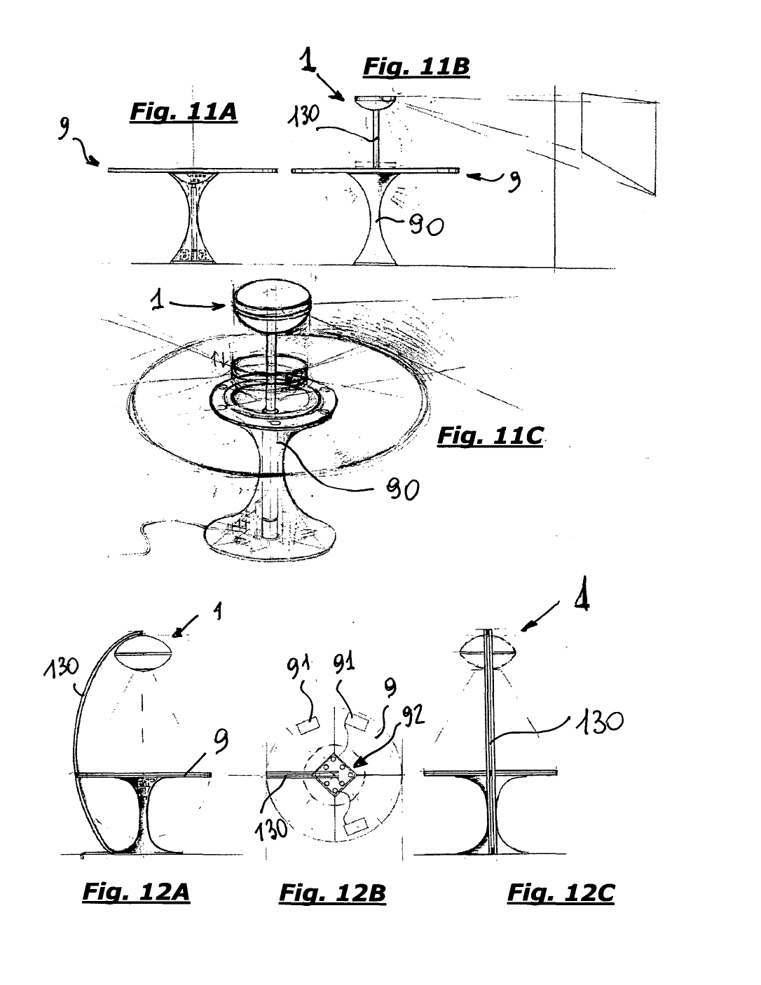

FIGS. 12A, 12B, 12C show schematically in a side view, in a plan view from above, and, respectively, in a rear view, another embodiment of the invention, in which the apparatus is supported by a rod associated with a table and it is placed above the table, table being provided with a plurality of connections for computers;

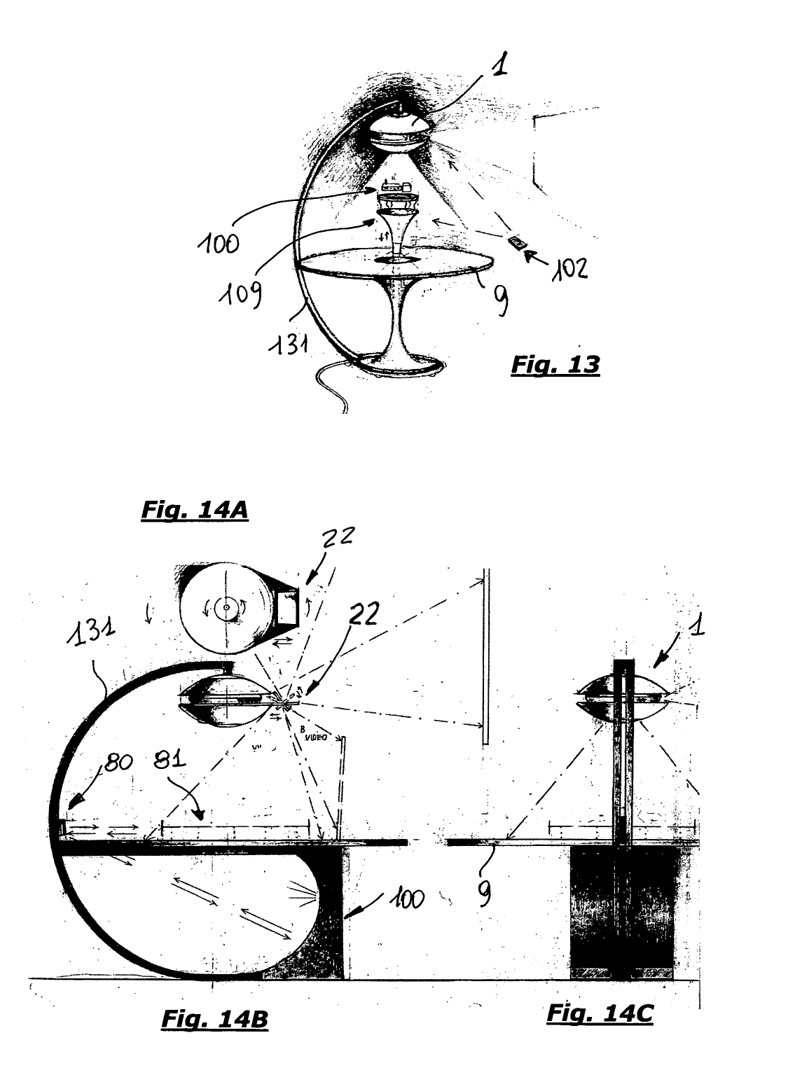

the FIG. 13 shows schematically, in perspective view, another further example of the invention, in which the apparatus is supported by a stem associated with a table and it is placed above the table, as in the example of FIGS. 12A-C, with the table that, in this case, incorporates the control unit of the apparatus;

FIGS. 14A, 14B, 14C show schematically, respectively in a plan view from below, in a side view and a rear view, another example of the invention, in which the apparatus is supported by a stem associated with a table and is placed above the table, with the table that is provided with a device with an interactive projection system.

With reference to the accompanying drawings, a multimedia apparatus according to the invention comprises:
a control unit (100) which comprises an audio/video source and/or is connected to an external audio/video source;
a structure (1) for playing audio/video connected to said control unit (100) and provided with at least one projector (2), i.e. with means for displaying images (2); said structure (1) being positionable according to different configurations in order to place correspondingly said projector (2), with the possibility of lifting, lowering and/or rotate around a vertical axis the same projector.

In particular, the control unit (100) and the structure for the audio/video (1) are wireless connected.

The control unit (100) can incorporate the means for audio/video playing, as, for example, CD, DVD and the like and can be provided with means for connecting to audio/video sources. In practice, the control unit can be connected to the Internet or another computer network or via satellite or terrestrial antenna to receive signals relating to images, movies, television programs, information, games, etc. . . . The block (101) schematically indicates the connection of the unit (100). The unit (100) is advantageously provided with a plurality of inputs for connecting to different devices of various kinds; the unit can be provided, for example, with USB ports, memory card slot for audio/video, etc. . . .

The structure for audio/video (1) playing is also provided with an audio player (3). In practice, the structure (1) will be provided with speakers (3) capable of playing sounds, which can be related to any video transmitted from the projector (2), or independently of the latter. In the examples of the drawings it is possible to note that the placement (i.e. as opposed stereo) of the speakers (3), allows an optimal sound reproduction, and also an enrichment of the design of the structure. In the examples, the structure for the audio/video playing (1) includes at least one light source (4). The source (4) can be a LED lamp, halogen lamp, or otherwise. Advantageously, the apparatus can be provided with multi-color sources for an attractive color effect.

As in some of the examples shown in the drawings (for example in FIGS. 4A-D), the structure for the audio/video playing (1) can be comprise two half-shells (11, 12) that can be approached and moved away each other to be placed in an a closed or in an open configuration, in which the transmitting section of said projector (2) is exposed or active. In practice, the apparatus has a proper function even when the projector is not used, since it can be used as a lamp, in a good aesthetic effect.

As stated above, the structure (1) can be differently shaped in order to be placed in different ways. In FIGS. 2A, 3A-D is represented a device attached directly to the ceiling and which can be lowered thanks to a pair of telescopic legs attached to a top base (131) that can rotate. In FIGS. 2B, 4A-D, 5A-B, 6A-C, 7A-F is represented an apparatus attached to the ceiling with a rod. FIG. 2C shows an apparatus which is placed on the floor by means of a foot.

Thanks to the stretching or the shortening of the telescopic stem (13), the structure (1) is raised or lowered and, thanks to the rotation around the longitudinal axis of the stem (13), structure (1) can be directed to accordingly direct the projector (2).

The control unit (100) can be remotely controlled by a remote control (102).

In the embodiment of FIGS. 8A-F the projector (2) is integrated with a mirror element (22) that can protrude from the body of the projector (2), as indicated by arrows. The apparatus (1) can rotate around the vertical axis defined by the stem (13) and it can be lowered and raised with the possibility of extension of the same stem (13); furthermore, the projection of the projector (2) can be directed in different directions (by rotating 360°) on the horizontal plane in which the projector (2) is placed and it can also be directed upwards and downwards by the mirror element (22). The apparatus can be provided with two engines: one for the extraction and retraction of the rods (220) in respect to the body of the projector, the other for the rotation of the mirror (22) around the axis (221). The apparatus (1) therefore has two active configurations for projecting: one in which the reflecting element is not extracted from the apparatus and the projector can project in a horizontal direction, the other with the mirror (22) protruding from the apparatus and reflecting the projection of the projector down (as in FIG. 8D) or upward (as in FIG. 8E).

The example shown in FIGS. 9A-C has a substantially circular shape in plan and the element is equipped with the mirror element. The structure of the apparatus (1) has the two halves (11, 12) that can be removed and approached as described for the previous examples; the apparatus (1) is provided with a peripheral crown (440) on which are placed light elements, such as LEDs that project its light toward the shells, which are made by reflective material. The crown (440), made of metal, allows optimum heat dissipation, both from Led (44) and from the projector (2).

The example of FIGS. 10A-C has a substantially circular shape in plan and the apparatus is provided with a mirror. The structure of the apparatus (1) has the two halves (11, 12) that can be removed and approach as described for the previous examples; the apparatus (1) is provided, on the top and on the bottom, with a pair of rings (450) on which are arranged light elements, such as LEDs that project its light toward the shells (11, 12), which are in reflective material and are enclosed by two semi-shells in transparent material (110, 120).

The example of FIGS. 11A-C shows the apparatus (1) supported by a table (9); the apparatus slides vertically upwards from the tabletop when it is used, both as a projector lamp as supported by a stem (130). When used, the apparatus comes out of the tabletop.

The apparatus of FIG. 12A-C is supported by a stem associated with a table (9) which is provided with a plurality of connections (92) for computers (91).

In the example of FIG. 13 the apparatus (1) is supported by a stem (13) associated with a table (9) and is placed above the table, as in the example of FIGS. 12A-C, supported by the stem (131); in this case, the table incorporates the control unit (100) apparatus, which is contained in a casing (109) which is inside the table (9). The apparatus (1) can also project on the table or other surfaces more or less close to those using the table (9).

Finally, the example of FIG. 14A-C relates to an apparatus (1) supported by a stem (131) associated with a table (9) and it is disposed above the table, table that is equipped with a device with interactive projection system (80), able to define a virtual surface interactive. An example of such a device is known as “Pandora Box”, for example of the type “Interactive Led Wall” or the like.

In practice, the construction details may vary in any equivalent way as regards the shape, dimensions, disposition of elements, nature of the used material, without nevertheless departing from the scope of the adopted solution idea and thereby remaining within the limits of the protection granted to the present patent.

1. A multimedia apparatus, comprising:
a control unit which comprises an audio/video source and/or is connected to audio/video source;
a structure for audio/video reproduction connected to said control unit and provided with at least a means for displaying images, said structure being positionable according to different configurations in order to place correspondingly said means for displaying images, wherein said means for displaying images is capable of being lifted, lowered and/or rotated around a vertical axis thereof;
a reflecting element adjustable, placed in correspondence of said means for displaying images, capable of diverting at least vertically, a projection out from said means for displaying images.

2. An apparatus according to claim 1, wherein the structure for the audio/video reproduction consists of two semi-shells which can be reciprocally approached and spaced to be placed in a closed configuration or in a open configuration in which an emitting part of said means for displaying images is exposed or active, said means for displaying images comprising a projector.

3. A multimedia apparatus, comprising:
a control unit which comprises an audio/video source and/or is connected to audio/video source;
a structure for audio/video reproduction connected to said control unit and provided with at least a means for displaying images, said structure being positionable according to different configurations in order to place correspondingly said means for displaying images, wherein said means for displaying images is capable of being lifted, lowered and/or rotated around a vertical axis thereof, said structure being composed of two semi-shells which can be reciprocally approached and spaced to be placed in a closed configuration or in a open configuration in which an emitting part of said means for displaying images is exposed or active.

4. An apparatus according to claim 1, wherein the control unit and the structure for the audio/video playing are wirelessly connected.

5. An apparatus according to claim 1, wherein the structure for audio/video reproduction includes at least an audio player.

6. An apparatus according to claim 1, wherein the structure for the audio/video reproduction includes at least a light source.

7. An apparatus according to claim 1, wherein the structure for the audio/video reproduction is connected to at least a telescopic rod, associable with a ceiling or similar fixed structure, so as to vary a height of said structure.

8. An apparatus according to claim 7, wherein said at least said telescopic rod can rotate around a longitudinal axis thereof.

9. An apparatus according to claim 1, wherein the control unit is remotely controlled by a remote control.

10. An apparatus according to claim 6, wherein the light source is multi-color.

11. An apparatus according to claim 6, wherein said light source is formed by a plurality of light elements supported by a crown with an ability to dissipate heat.

12. An apparatus according to claim 5, wherein the structure for audio/video reproduction includes at least another audio player to provide at least two audio players, said at least two audio players being arranged opposite one another.

13. An apparatus according to claim 1, wherein the structure for audio/video reproduction is permanently associated with a table, which contains said control unit.

14. An apparatus according to claim 3, wherein the structure for audio is permanently associated with a table, which contains said control unit and which is provided with a device for displaying images in an interactive way.

15. An apparatus according to claim 3, wherein the control unit and the structure for the audio/video playing are wirelessly connected.

16. An apparatus according to claim 3, wherein the structure for audio/video reproduction includes at least an audio player.

17. An apparatus according to claim 3, wherein the structure for the audio/video reproduction includes at least a light source.

18. An apparatus according to claim 3, wherein the structure for the audio/video reproduction is connected to at least a telescopic rod, associable with a ceiling or similar fixed structure, so as to vary a height of said structure.
